(19) United States
(12) Patent Application Publication
(10) Pub. No.: US 2025/0156226 A1
(43) Pub. Date: May 15, 2025

(54) DYNAMICALLY CHANGE DIRECT MEMORY ACCESS SIZE OF A DRIVER USING A MULTI-HANDLE APPROACH

(71) Applicant: INTERNATIONAL BUSINESS MACHINES CORPORATION, ARMONK, NY (US)

(72) Inventors: Phani Kumar V. U. Ayyagari, Hyderabad (IN); Yadagiri Rajaboina, Hyderabad (IN)

(21) Appl. No.: 18/509,446

(22) Filed: Nov. 15, 2023

(51) Int. Cl. G06F 9/50

(52) U.S. Cl. CPC G06F 9/5016; G06F 9/5055

(57) ABSTRACT

Embodiments dynamically change direct memory access size of a driver using a multi-handle approach. A technique includes monitoring a counter for a software channel, the software channel being coupled to a storage system, the software channel being configured to process an input/output (I/O) request for the storage system and receiving a request to modify a direct memory access (DMA) size of the software channel based on the counter reaching a predetermined threshold. A number of DMA handles associated with the software channel is modified, based on receiving the request to modify the DMA size of the software channel.

### BACKGROUND

The present invention generally relates to computer systems, and more specifically, to computer-implemented methods, computer systems, and computer program products configured and arranged to dynamically change direct memory access size of a driver using a multi-handle approach.

Direct memory access is a feature of computer systems and allows certain hardware subsystems to access main system memory independently of the central processing unit. Without direct memory access, when the central processing unit is using programmed input/output, it is typically fully occupied for the entire duration of the read or write operation and is thus unavailable to perform other work. With direct memory access, the central processing unit first initiates the transfer, then it does other operations while the transfer is in progress, and it finally receives an interrupt from the direct memory access controller when the operation is done. This feature is useful at any time that the central processing unit (CPU) cannot keep up with the rate of data transfer or when the CPU needs to perform work while waiting for a relatively slow input/output data transfer. Many hardware systems use direct memory access, including disk drive controllers, graphics cards, network cards, and sound cards. Direct memory access is also used for intra-chip data transfer in multi-core processors. Computers that have direct memory access channels can transfer data to and from devices with much less CPU overhead than computers without direct memory access channels.

### SUMMARY

Embodiments of the present invention are directed to computer-implemented methods for dynamically changing direct memory access size of a driver using a multi-handle approach. A non-limiting computer-implemented method includes monitoring a counter for a software channel, the software channel being coupled to a storage system, the software channel being configured to process an input/output (I/O) request for the storage system. The method includes receiving a request to modify a direct memory access (DMA) size of the software channel based on the counter reaching a predetermined threshold and modifying a number of DMA handles associated with the software channel, based on receiving the request to modify the DMA size of the software channel.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of the example computing environment configured to dynamically change direct memory access size of a driver using a multi-handle approach according to one or more embodiments of the present invention;

FIG. 3 is a flowchart of a process for dynamically changing direct memory access size of a driver using a multi-handle approach in order to process I/O requests to a storage system according to one or more embodiments of the present invention;

FIG. 4 is a flowchart of a process for dynamically changing direct memory access size of a driver using a multi-handle approach so that the DMA space used by the driver can be increased dynamically without stopping the I/O requests to a storage system according to one or more embodiments of the present invention;

FIG. 5 is a flowchart of a process for dynamically changing direct memory access size of a driver using a multi-handle approach so that the DMA space used by the driver can be decreased dynamically without stopping the I/O requests to a storage system according to one or more embodiments of the present invention;

FIG. 6 depicts block diagrams of example DMA resource allocations according to one or more embodiments of the present invention; and

FIG. 7 is a flowchart of a computer-implemented method for dynamically changing direct memory access size of a driver using a multi-handle approach in order to process I/O requests to a storage system according to one or more embodiments of the present invention.

### DETAILED DESCRIPTION

One or more embodiments of the invention describe computer-implemented methods, computer systems, and computer program products configured and arranged to dynamically change direct memory access size of a driver using a multi-handle approach in order to process input/output (I/O) requests for a storage system. The multi-handle approach is utilized to increase and decrease the size of the direct memory access space dynamically so that I/O requests do not need to be stopped or wait, according to one or more embodiments. Accordingly, techniques are provided that dynamically increase and decrease direct memory access resources without impacting the ongoing I/O operation.

Dynamic memory access (DMA) resources are important for I/O requests to complete when using all peripheral component interconnect express (PCIe) based adapters. The direct memory access resources are allocated once during the driver initialization time. For example, the default value of this attribute (i.e., the dynamic memory access space) may be set to 512 megabytes (MB), and max support value is 2 gigabytes (GB). When there is a heavy I/O workload (for I/O requests), DMA resources will be exhausted, and the I/O requests are buffered so as to wait in the pending queues, all of which degrades the read and write performance of the workload. Particularly, it is the fiber channel device driver's responsibility to ensure enough DMA resources are available to be able to read or write the data buffers for I/O requests. When such DMA resources are not available, the corresponding I/O request is temporarily held with the driver's internal queues for a specific time period and once the resources are available, the I/O is issued to the fiber channel host bus adapter firmware. Further, in cloud environments, the I/O workload changes sporadically. In such cases noted above, the driver has to be unconfigured and configured again, which demands the I/O requests be completely stopped, all of which further degrades the read and write performance of the memory.

As technical solutions and benefits, the direct memory access space that is used by the driver can be increased/decreased dynamically without disturbing the (current) I/O requests, thereby resulting in increased performance by the computer system. The multi-handle approach is especially useful where there is no kernel service. According to one or more embodiments, the multi-handle approach to dynamically increase/decrease the direct memory access space of the driver is particularly beneficial in cloud environments where the I/O workloads change very frequently and cannot tolerate resource shortages. The host bus adapter firmware supports multi-queuing and hence multiple software channels are created in the driver to drive the I/O. Embodiments are configured to create DMA handles per channel without disturbing the ongoing I/O requests. For example, when the device driver is initially configured, the device driver allocates multiple DMA handles with the same size across all the channels. When a user requests the enhanced value, the device driver creates additional DMA handles of the same size and distributes the newly created DMA handles across all the channels. By default, when processing an I/O request for a channel, the I/O request is sent on (i.e., assigned to) the first DMA handle of that channel. If the DMA resources are not available on the first handle, then the device driver uses the next DMA handle and proceeds with the data transfer for the I/O request. If a decrease request is initiated, the DMA handles are marked for deletion to prevent any I/O request from using the marked DMA handle, and the marked DMA handles are deleted one by one until requested size is met. Each channel maintains a counter which will be incremented when there are no DMA resources. This counter can be used to select a channel in which a new DMA handle has to be allocated. A high value of the counter indicates that the corresponding channel does not have sufficient DMA handles with I/O capacity to satisfy the I/O request; as such the corresponding channel is a candidate to add DMA handles. A lower value of the counter indicates that there are sufficient DMA handles for this channel, and channel is a candidate for deleting DMA handles.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as driver software 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

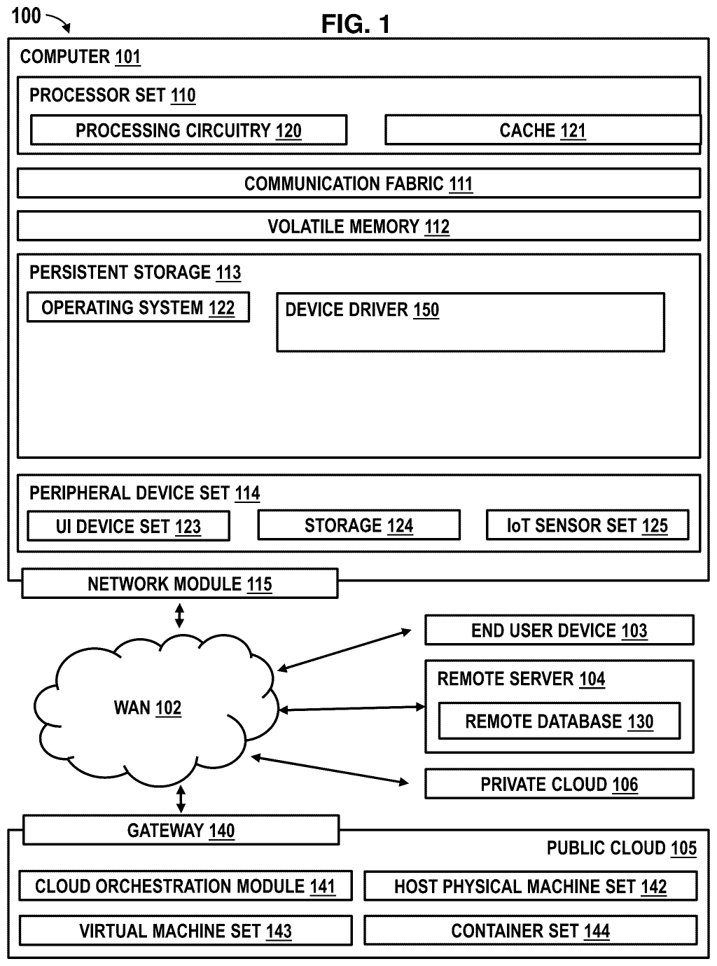

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

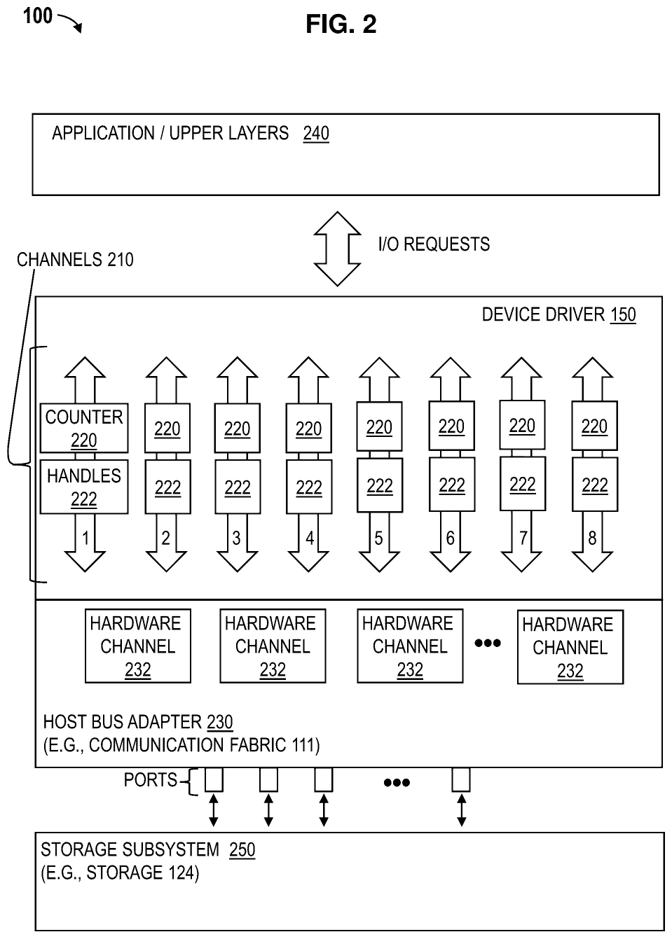

FIG. 2 depicts the computing environment 100 with further details for dynamically changing direct memory access size of a driver using a multi-handle approach according to one or more embodiments. In FIG. 2, some details of the computing environment 100 may be omitted so as not to obscure the figure. FIG. 2 illustrates various software applications in the application/upper layers 240 that have input/output (I/O) requests that are to transfer data to/from a storage subsystem 250. An example of the storage subsystem 250 is storage 124. Application/upper layers 240 may execute on computer 101 and/or other computer systems like computer 101. The application/upper layers 240 may be for software applications for various devices that may be coupled to the computer 101 or other computer systems like computer 101.

The device driver software 150 is configured to allocate and initialize DMA related resources to process the I/O requests from the application/upper layers 240. The device driver software 150 is configured to use software channels 210 to transfer data for the I/O requests on hardware channels 232 of an adapter, such as host bus adapter 230. The software channels 210 are logical channels for which hardware resources of the hardware channels 232 have been provided. Each software channel 210 has its own counter 220 and one or more DMA handles 222. For illustration purposes, eight software channels are illustrated but there can be more or fewer than eight software channels 210. The host bus adapter 230 can be coupled to the computer 101 and the storage subsystem 250. In one or more embodiments, the host bus adapter 230 may be implemented as part of the communication fabric 111. A host bus adapter (HBA) is a circuit board or integrated circuit adapter that connects a host system, such as a server, to a storage or network device. The HBA also provides I/O processing to reduce the load on the host's microprocessor when storing and retrieving data, helping to improve the host's overall performance. In one or more embodiments, the device driver software 150 may employ rules-based algorithms to dynamically change direct memory access size of a driver using a multi-handle approach as discussed herein.

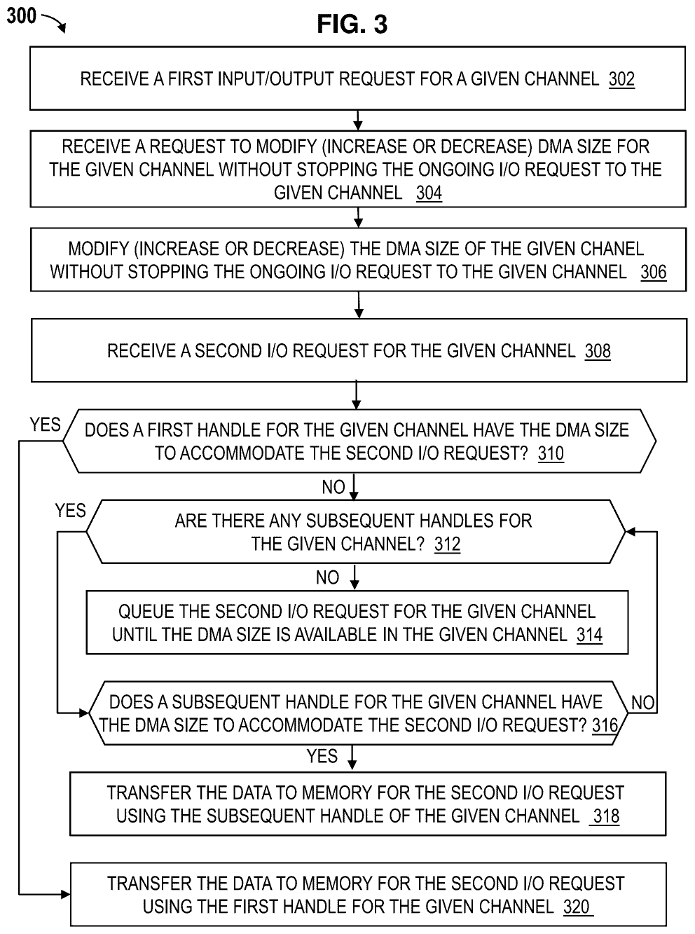

FIG. 3 is a flowchart of a computer-implemented method 300 for dynamically changing direct memory access size of a driver using a multi-handle approach in order to process I/O requests to a storage system according to one or more embodiments. In the description of the computer-implemented method 300 in FIG. 3, reference can be made to FIGS. 1 and 2. For explanation purposes, individual I/O requests to transfer data, such as to receive data or send data, are discussed one at a time in an example scenario, but it should be appreciated that the device driver software 150 is configured to currently process numerous I/O requests.

At block 302 of the computer-implemented method 300, the device driver software 150 is configured to receive a first I/O request for a given software channel 210, for example, software channel 1. Based on an attribute from the application/upper layers 240 (or protocol layer), the device driver software 150 is configured to perform a hash function on the attribute to determine the particular software channel to use. In one or more embodiments, the device driver software 150 may utilize another method to determine the software channel required for the I/O request. The device driver software 150 is configured to continue processing the ongoing first I/O request for the transfer data to/from the storage subsystem 250.

At block 304, the device driver software 150 is configured to receive a request to modify (e.g., increase or decrease) the DMA size for the given channel without stopping the ongoing first I/O request on the given channel. The ongoing first I/O request continues as it is with the currently existing DMA handle. When a new DMA handle allocation is completed, the new DMA handle(s) can be used to drive other I/O requests as discussed further herein.

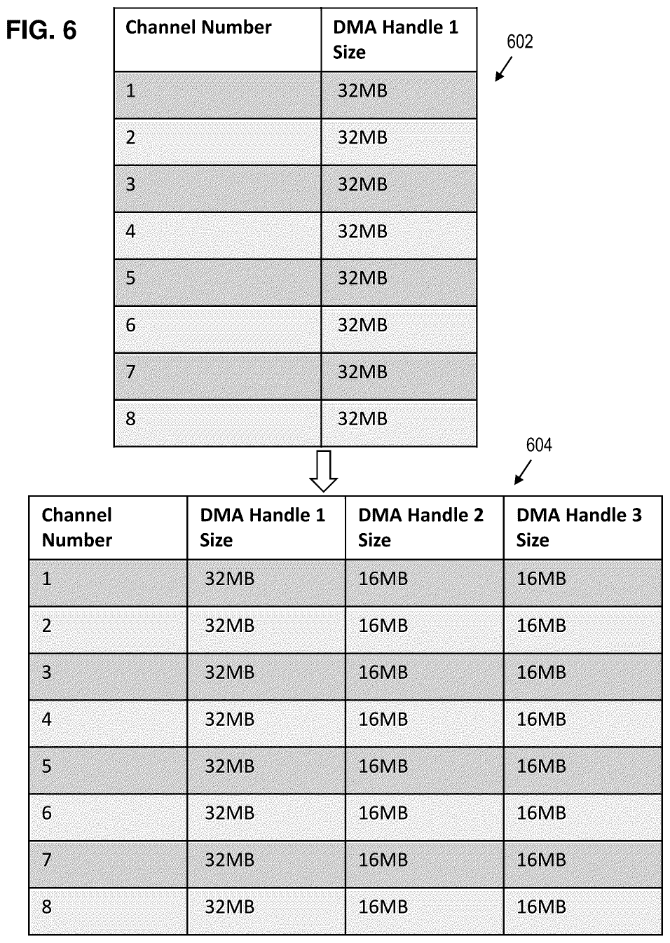

A DMA handle is a unique identification (ID) corresponding to an allocation size of hardware resources given to a software channel 210 to transfer data over the hardware resources. The host bus adapter 230 has hardware channels 232 as hardware resources for transferring data of I/O requests to/from the storage subsystem 250. In FIG. 6, DMA resource allocation table 602 illustrates that the device driver software 150 has allocated a DMA handle 1 with a DMA size of 32 MB. Following the example scenario, the given software channel (e.g., software channel 1) has a default DMA size of 32 MB for the DMA handle 1, as depicted in the DMA resource allocation table 602. Each of the software channels 210 is allocated DMA handle 1 with the example default size 32 MB.

As will be discussed further according to one or more embodiments, in each software channel, the 32 MB default handle 1 is tried first for an I/O request, and if “NO DMA Resource” error is returned, then a subsequent handle is tried (if present) (no subsequent handle is illustrated in the DMA resource allocation table 602). The recently used DMA handle, for example, a subsequent DMA handle, can be marked and used next time without having to try any previous DMA handles for the given software channel. On the other hand, there may not be a subsequent handle for the software channel because the subsequent DMA handle has not yet been created. Accordingly, the device driver software 150 maintains a counter to indicate which software channel is having multiple “No DMA Resource” errors, and this indicates the software channel for which an additional DMA handle is needed in order to supply an increased DMA size for the software channel. This results in the generation of a notification as a request to modify the DMA size for the software channel (i.e., add another DMA handle). In some cases, a user can initiate the request to modify the DMA size for the software channel.

At block 306, the device driver software 150 is configured to modify (increase or decrease) the DMA size of the given software channel 210 without stopping the ongoing first I/O request to the given software channel 210. Also, this is without stopping other data transfers for I/O requests of other software channels on the device driver software 150. For example, there can be two or more DMA handles for software channel 1 as depicted in a DMA resource allocation table 604, which means that the DMA resource allocation table 602 has been dynamically changed to the DMA resource allocation table 604 according to one or more embodiments. In some cases, the other software channels or one or more of the other software channels may only have DMA handle 1 and may not have DMA handle 2 and DMA handle 3 shown in the DMA resource allocation table 604. In an example cases, it is assumed that the software channel 1 (only) has DMA handle 1 and 2, and accordingly, the device driver software 150 is configured to decrease the DMA size of software channel 1 by removing DMA handle 2, which removes 16 MB of I/O capacity from the software channel 1.

On the other hand, it is assumed that the request is to increase the DMA size of software channel 1. Accordingly, the device driver software 150 is configured to increase the DMA size of the software channel 1 by a predetermined increment (e.g., 16 MB) by adding a DMA handle 2 to the I/O capacity of the software channel 1. For example, it can be assumed that the DMA handle 2 has been added to the software channel 1 in the DMA resource allocation table 604 but DMA handle 3 has not yet been added. In another case, it can be assumed that DMA handle 3 is being added to the software channel 1, as a result of the request to increase the DMA size of the software channel 1 because the DMA handle 2 is already present. In any case, the DMA handle is added to (or removed from) a specific software channel without affecting the number of DMA handles of any other software channel.

At block 308, the device driver software 150 is configured to receive a second I/O request for the given software channel 210. At block 310, the device driver software 150 is configured to check whether a first DMA handle (e.g., DMA handle 1 as the default handle) for the given software channel has the available DMA size to accommodate the second I/O request. If (Yes) the first DMA handle has the DMA size to accommodate data for the second I/O request, the device driver software 150 is configured to transfer the data to (or from) the storage subsystem 250 for the second I/O request using the first DMA handle for the given software channel, at block 320.

At block 312, if (No) the first DMA handle for the given software channel 210 does not have the DMA size to accommodate the second I/O request, the device driver software 150 is configured to check whether there are any subsequent DMA handles for the given software channel.

At block 314, if (No) there are not any subsequent DMA handles for the given software channel, the device driver software 150 is configured to queue the second I/O request for the given channel until the DMA size is available in the given software channel. In one case, the number of DMA handles for the software channel 1 is illustrated in the DMA resource allocation table 602, and a single DMA handle 1 (e.g., the default DMA handle) has been allocated for the software channel 1; as such, there are no subsequent DMA handles available for the software channel 1 when the DMA handle 1 of the software channel 1 cannot accommodate the second I/O request. For example, the amount of DMA space allocated is being used by the ongoing I/O requests. As such, there is no DMA space to honor new I/O requests.

At block 316, if (Yes) there are any subsequent DMA handles (e.g., at least one subsequent DMA handle) for the given software channel 210, the device driver software 150 is configured to check whether the subsequent DMA handle for the given software channel 210 has the DMA size to accommodate the second I/O request. If not, flow returns to block 312 to check whether the given software channel 210 has another DMA handle that has not been checked.

At block 318, if (Yes) there is a subsequent DMA handle for the given software channel 210 that has the DMA size to accommodate the second I/O request, the device driver software 150 is configured transfer the data to (or from) the storage subsystem 250 using the subsequent DMA handle of the given software channel 210. In one instance, the DMA resource allocation table 604 may include the software channel 1 which has DMA handle 1, DMA handle 2, and DMA handle 3. After checking and determining that the DMA handle 1 (e.g., default handle) does not have the available DMA size to accommodate the second I/O request, the device driver software 150 checks the DMA handle 2, when the DMA handle 2 of the software channel 1 has the available DMA size to accommodate the data requirement of the second I/O request, the device driver software 150 causes the DMA handle 2 of the software channel 1 to be utilized to transfer the data to (or from) the storage subsystem 250 for the second I/O request, without requiring the device driver software 150 to be reconfigured and even without stopping the first I/O request on DMA channel 1 of the software channel 1.

In another instance, if DMA handle 2 of the software channel 1 did not have the available DMA size to accommodate the second I/O request, the device driver software 150 checks and uses DMA handle 3 of the software channel 1 to transfer data for the second I/O request, without stopping and reconfiguring the device driver software 150 for software channel 1, without interrupting the first I/O request on DMA handle 1, and without interrupting any I/O request on DMA handle 2 of the software channel 1.

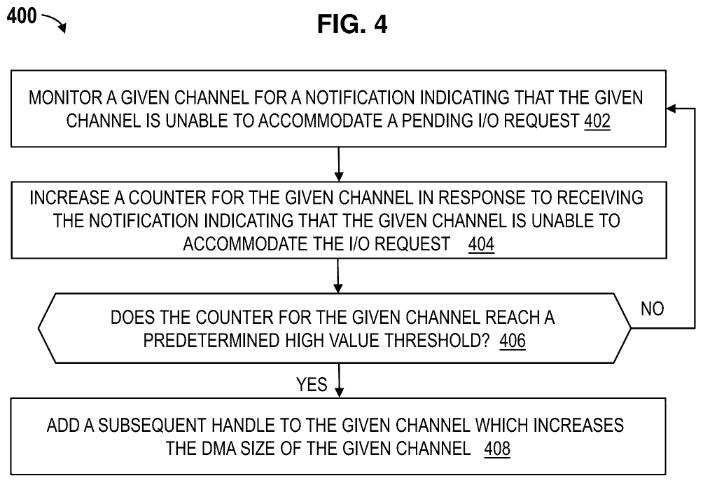

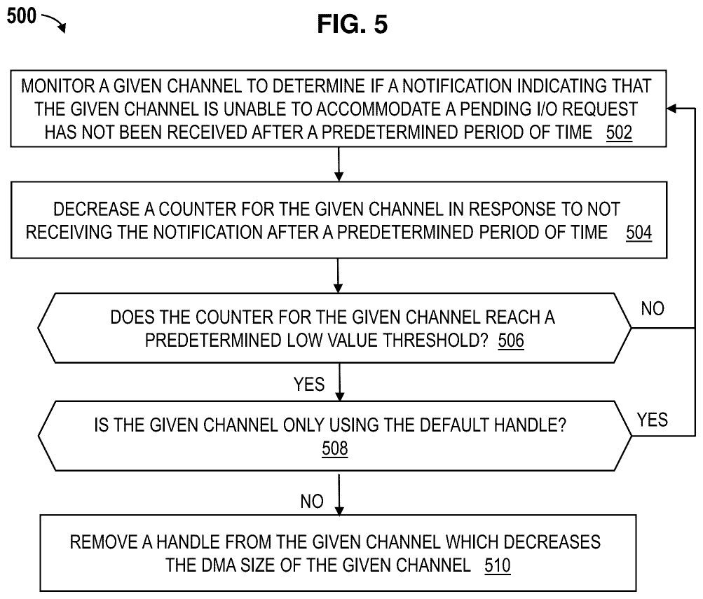

FIG. 4 is a flowchart of a computer-implemented method 400 for dynamically changing direct memory access size of a driver using a multi-handle approach so that the DMA space used by the driver can be increased (or decreased in FIG. 5) dynamically without stopping the I/O requests of the driver to a storage system according to one or more embodiments. At block 402, the device driver software 150 is configured to monitor a given software channel 210 for a notification indicating that the given software channel is unable to accommodate a pending I/O request. At block 404, the device driver software 150 is configured to increase the counter 220 for the given software channel 210 in response to receiving the notification indicating that the given software channel is unable to accommodate the I/O request. The device driver software 150 maintains a counter 220 for each given software channel to track/count which software channel is having a “No DMA Resource” error. Each software channel has its own counter 220. At block 406, the device driver software 150 is configured to check if the counter 220 for the given software channel 210 has reached a predetermined high value threshold. The predetermined high value threshold is known in advance. If no, the flow returns to block 402. At block 408, if (Yes) the counter for the given software channel 210 has reached the predetermined high value threshold, the device driver software 150 is configured to add a subsequent DMA handle to the given software channel 210 which increases the DMA size of the given software channel (without stopping/interrupting) any ongoing I/O requests. The device driver software 150 does not have to be unconfigured and then configured again to increase and/or decrease the number of DMA handles for a given software channel. Since the DMA initialization happens only at driver initialization time and is not touched again, the device driver software 1504 has to be reinitialized which means unloading the driver and loading the driver again. For device driver software to be unloaded, there should not be any ongoing I/O requests (i.e., no I/O data transfers). The I/O can be file system I/O or raw I/O. In that case, the filesystem has to unmounted (stopping the I/O or stopping the workload) before proceeding with unloading the device driver software. This is a large time consuming activity if the device driver does not implement the dynamic tuning of DMA resources as disclosed in one or more embodiments.

In the example scenario, it is assumed that the given software channel is software channel 1, but it should be appreciated that the discussion for increasing DMA handles and/or decreasing DMA handles applies to one, two, three, four, and/or all software channels concurrently. In the DMA resource allocation table 602, the software channel 1 has the single DMA handle 1 (i.e., the default DMA handle). After meeting the predetermined high value threshold, the device driver software 150 add an additional handle, for example, DMA handle 2 in a predetermined DMA size (e.g., 16 MB) for software channel 1 (only), as depicted in the DMA resource allocation table 604 but without adding DMA handle 3 in an example case. Additionally, or alternatively, in another instance, the software channel 1 may already have DMA handle 2, and the device driver software 150 adds DMA handle 3 in the predetermined DMA size (e.g., 16 MB), as depicted in the DMA resource allocation table 604. In the DMA resource allocation table 604, the example maximum DMA size/space of the entire device driver software 150, for example, for all software channels 1-8, is 512 MB. The DMA handle 1 for each of the software channels 1-8 may be fixed at the DMA size of 32 MB, and the increase per DMA handle is fixed at another predetermined DMA size (e.g., 16 MB). The converse is true in which the decrease per DMA handle is at the same predetermined DMA size. Further, it should be appreciated that the device driver software 150 is configured to allow the data transfer of the I/O to run on the default handle in the device driver software 150. This will make sure the ongoing I/O request has time to continue until it is completed. This occurs without destroying the default handle such that creating new DMA handles does not affect the I/O request running on the default DMA handle, without stopping the I/O. Moreover, the I/O continues on first DMA handle (i.e., the default DMA handle) until or while new handles are created to accommodate the new size requirements.

FIG. 5 is a flowchart of a computer-implemented method 400 for dynamically changing direct memory access size of a driver using a multi-handle approach so that the DMA space used by the driver can be decreased dynamically without stopping the I/O requests to a storage system according to one or more embodiments. At block 502, the device driver software 150 is configured to monitor a given software channel 210 to determine if a notification indicating that the given software channel 210 is unable to accommodate a pending I/O request has not been received after a predetermined period of time. The predetermined period of time may be 5, 10, 15, 30 minutes or so forth. At block 504, the device driver software 150 is configured to decrease the counter 220 for the given software channel 210 in response to not receiving the notification indicating that the given software channel 210 is unable to accommodate a pending I/O request after a predetermined period of time. As noted above, the device driver software 150 maintains a counter 220 for each given software channel to track/count which software channel is receiving a “No DMA Resource” error and/or not receiving the error over a predetermined period of time. At block 506, the device driver software 150 is configured to check if the counter 220 for the given software channel 210 has reached a predetermined low value threshold. The predetermined low value threshold is known in advance. If no, the flow returns to block 502. At block 508, if (Yes) the counter 220 for the given software channel 210 has reached the predetermined low value threshold, the device driver software 150 is configured to check if the given software channel 210 is only using the default DMA handle (e.g., the software channel only has the DMA handle 1). If (Yes), the flow returns to block 502. At block 510, if (No) there are other DMA handles for the given software channel 210, the device driver software 150 is configured to decrease a subsequent DMA handle (e.g., the last of the consecutive DMA handles) for the given software channel 210 which decreases the DMA size of the given software channel (without stopping/interrupting) any ongoing I/O requests. This ensures that the default DMA handle is not removed for the given software channel. Again, when removing the DMA handle, the device driver software 150 does not have to be unconfigured and then configured again.

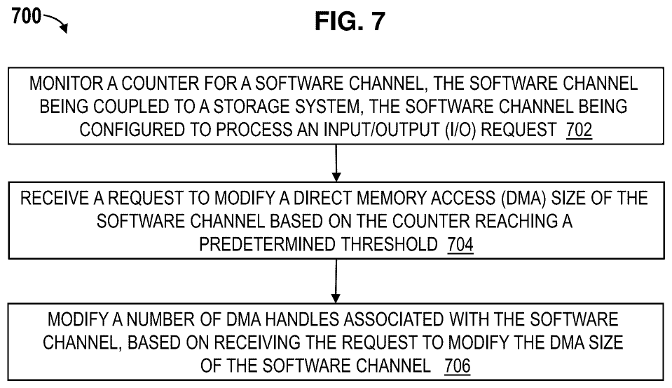

FIG. 7 is a flowchart of a computer-implemented method 700 for dynamically changing direct memory access size of a driver using a multi-handle approach while continuously processing I/O requests according to one or more embodiments. Reference can be made to any of the figures discussed herein.

At block 702 of the computer-implemented method 700, the device driver software 150 is configured to monitor a counter 220 for a software channel 210, the software channel being coupled to a storage system (e.g., storage subsystem 250), the software channel being configured to process an input/output (I/O) request (e.g., from the application/upper layers 240) for the storage system (e.g., storage subsystem 250). At block 704, the device driver software 150 is configured to receive a request to modify a direct memory access (DMA) size of the software channel 210 based on the counter 220 reaching a predetermined threshold. The device driver software 150 may generate the request or the request to modify can be user generated. The user may set a condition for which the request to modify is generated. At block 706, the device driver software 150 is configured to modify a number of DMA handles associated with the software channel 210, based on receiving the request to modify the DMA size of the software channel.

Further, in response to the request to modify the DMA size of the software channel being to increase the DMA size, an additional DMA handle is created for the software channel 210. In response to the request to modify the DMA size of the software channel being to decrease the DMA size, a DMA handle is deleted for the software channel 210.

The device driver software 150 is configured to send the I/O request to a first DMA handle (e.g., DMA handle 1) of the DMA handles of the software channel by default and proceed to use a second DMA handle (e.g., DMA handle 2) of the DMA handle for the software channel, in response to the first DMA handle (e.g., DMA handle 1) failing to have available DMA resources to accommodate the I/O request. Available DMA resources refer to the available capacity on a DMA handle, where the total DMA resource may be 32 MB but the available DMA resources are 3 MB which is not enough to accommodate the I/O request (e.g., the I/O request may require 16 MB).

The device driver software 150 is configured to mark a DMA handle (e.g., DMA handle 2 or DMA handle 3) for deletion in the software channel 210 upon initiation of the request to modify the DMA size and prevent any incoming I/O request assigned to the software channel from using the DMA handle marked for deletion. The device driver software 150 is configured to delete any DMA handle of the software channel one by one until a requested DMA size (reduce the software channel 1 down to the default DMA size of 32 MB) is met in the request to modify the DMA size.

The device driver software 150 is configured to increment the counter 220 for the software channel 210 in a driver (e.g., the device driver software 150) when there is an error (e.g., “No DMA Resource”) associated with DMA resources for the software channel, wherein the predetermined threshold is a high value for increasing the number of the DMA handles associated with the software channel. The device driver software 150 is configured to decrement the counter 220 for the software channel in an absence of the error for a predetermined interval, wherein the predetermined threshold is a low value for decreasing the number of the DMA handles associated with the software channel, wherein the high value is greater than the low value.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
monitoring a counter for a software channel, the software channel being coupled to a storage system, the software channel being configured to process an input/output (I/O) request for the storage system;
receiving a request to modify a direct memory access (DMA) size of the software channel based on the counter reaching a predetermined threshold; and
modifying a number of DMA handles associated with the software channel, based on receiving the request to modify the DMA size of the software channel.

2. The computer-implemented method of claim 1, wherein in response to the request to modify the DMA size of the software channel being to increase the DMA size, an additional DMA handle is created for the software channel.

3. The computer-implemented method of claim 1, wherein in response to the request to modify the DMA size of the software channel being to decrease the DMA size, a DMA handle is deleted for the software channel.

4. The computer-implemented method of claim 1, further comprising:
sending the I/O request to a first DMA handle of the DMA handles of the software channel by default; and
proceeding to use a second DMA handle of the DMA handles for the software channel, in response to the first DMA handle failing to have available DMA resources to accommodate the I/O request.

5. The computer-implemented method of claim 1, further comprising:
marking a DMA handle for deletion in the software channel upon initiation of the request to modify the DMA size; and
preventing any incoming I/O request assigned to the software channel from using the DMA handle marked for deletion.

6. The computer-implemented method of claim 1, further comprising deleting a DMA handle of the software channel one by one until a requested DMA size is met in the request to modify the DMA size.

7. The computer-implemented method of claim 1, further comprising:
incrementing the counter for the software channel in a driver when there is an error associated with DMA resources for the software channel, wherein the predetermined threshold is a high value for increasing the number of the DMA handles associated with the software channel; and
decrementing the counter for the software channel in an absence of the error for a predetermined interval, wherein the predetermined threshold is a low value for decreasing the number of the DMA handles associated with the software channel, wherein the high value is greater than the low value.

8. A system comprising:
a memory having computer readable instructions; and
a computer for executing the computer readable instructions, the computer readable instructions controlling the computer to perform operations comprising:
monitoring a counter for a software channel, the software channel being coupled to a storage system, the software channel being configured to process an input/output (I/O) request for the storage system;
receiving a request to modify a direct memory access (DMA) size of the software channel based on the counter reaching a predetermined threshold; and
modifying a number of DMA handles associated with the software channel, based on receiving the request to modify the DMA size of the software channel.

9. The system of claim 8, wherein in response to the request to modify the DMA size of the software channel being to increase the DMA size, an additional DMA handle is created for the software channel.

10. The system of claim 8, wherein in response to the request to modify the DMA size of the software channel being to decrease the DMA size, a DMA handle is deleted for the software channel.

11. The system of claim 8, further comprising:
sending the I/O request to a first DMA handle of the DMA handles of the software channel by default; and
proceeding to use a second DMA handle of the DMA handles for the software channel, in response to the first DMA handle failing to have available DMA resources to accommodate the I/O request.

12. The system of claim 8, further comprising:
marking a DMA handle for deletion in the software channel upon initiation of the request to modify the DMA size; and
preventing any incoming I/O request assigned to the software channel from using the DMA handle marked for deletion.

13. The system of claim 8, further comprising deleting a DMA handle of the software channel one by one until a requested DMA size is met in the request to modify the DMA size.

14. The system of claim 8, further comprising:
incrementing the counter for the software channel in a driver when there is an error associated with DMA resources for the software channel, wherein the predetermined threshold is a high value for increasing the number of the DMA handles associated with the software channel; and
decrementing the counter for the software channel in an absence of the error for a predetermined interval, wherein the predetermined threshold is a low value for decreasing the number of the DMA handles associated with the software channel, wherein the high value is greater than the low value.

15. A computer program product comprising a computer readable storage medium having program instructions embodied therewith, the program instructions executable by a computer to cause the computer to perform operations comprising:
monitoring a counter for a software channel, the software channel being coupled to a storage system, the software channel being configured to process an input/output (I/O) request for the storage system;
receiving a request to modify a direct memory access (DMA) size of the software channel based on the counter reaching a predetermined threshold; and
modifying a number of DMA handles associated with the software channel, based on receiving the request to modify the DMA size of the software channel.

16. The computer program product of claim 15, wherein in response to the request to modify the DMA size of the software channel being to increase the DMA size, an additional DMA handle is created for the software channel.

17. The computer program product of claim 15, wherein in response to the request to modify the DMA size of the software channel being to decrease the DMA size, a DMA handle is deleted for the software channel.

18. The computer program product of claim 15, further comprising:
sending the I/O request to a first DMA handle of the DMA handles of the software channel by default; and
proceeding to use a second DMA handle of the DMA handles for the software channel, in response to the first DMA handle failing to have available DMA resources to accommodate the I/O request.

19. The computer program product of claim 15, further comprising:
marking a DMA handle for deletion in the software channel upon initiation of the request to modify the DMA size; and
preventing any incoming I/O request assigned to the software channel from using the DMA handle marked for deletion.

20. The computer program product of claim 15, further comprising deleting a DMA handle of the software channel one by one until a requested DMA size is met in the request to modify the DMA size.
